(19) United States
(12) Patent Application Publication
(10) Pub. No.: US 2025/0353352 A1
(43) Pub. Date: Nov. 20, 2025

(54) AUTOMOTIVE AIRFLOW CONTROL DEVICE AND CONTROL METHOD THEREFOR

(71) Applicants: HYUNDAI MOTOR COMPANY, Seoul (KR); KIA CORPORATION, Seoul (KR)

(72) Inventors: Sang Yeop Lee, Hwaseong-si (KR); Jae Won Heo, Hwaseong-si (KR); Seung Hoon Moon, Hwaseong-si (KR); Jung Mo Kwak, Hwaseong-si (KR); Young Su Nam, Hwaseong-si (KR); Myung Jun Kim, Hwaseong-si (KR); Jin Han Kim, Hwaseong-si (KR); Young Taek Hong, Hwaseong-si (KR); Gyeong Won Jeong, Hwaseong-si (KR); Kyeong Min Kang, Hwaseong-si (KR); Sang Shin Lee, Hwaseong-si (KR); Hae Ryong Park, Hwaseong-si (KR)

(73) Assignees: HYUNDAI MOTOR COMPAN, Seoul (KR); KIA CORPORATION, Seoul (KR)

(21) Appl. No.: 18/938,012

(22) Filed: Nov. 5, 2024

(30) Foreign Application Priority Data
May 20, 2024 (KR) 10-2024-0064986

(51) Int. Cl. B60H 1/00

(52) U.S. Cl. CPC B60H 1/00842; B60H 1/00735

(57) ABSTRACT

An automotive airflow control device includes one or more air vents mounted in a vehicle and configured to discharge cold air or warm air into a vehicle compartment. The device also includes a controller configured to receive open/closed information for the air vents to control airflow. The controller checks the number of closed air vents, calculates a control constant value based on the number of closed air vents, and controls airflow provided to the one or more air vents.

### CROSS-REFERENCE TO RELATED APPLICATION

This application claims, under 35 U.S.C. § 119(a), the benefit of and priority to Korean Patent Application No. 10-2024-0064986, filed on May 20, 2024, the entire contents of which are incorporated herein by reference.

### TECHNICAL FIELD

The present disclosure relates to an automotive airflow control device and a control method therefor. More particularly, the present disclosure relates to an automotive airflow control device and a control method therefor in which open/closed information for air vents mounted in a vehicle is collected to check the number of closed air vents.

### BACKGROUND

An automotive air conditioning system, i.e., a heating, ventilation, and air conditioning (HVAC) system is configured to control the air in a vehicle compartment, i.e., the vehicle interior or passenger compartment. Also, cold or warm air generated in the HVAC system is discharged through an air vent, which may be provided in the shape of an opening in a predetermined area, such as on a dashboard.

The air conditioning system has formed therein a passage through which air, blown by a blower, flows. The passage has heat exchangers mounted therein and configured to heat or cool the air. A plurality of doors is configured to distribute the warm or cold air heated or cooled by passing through the heat exchangers to various areas in the vehicle compartment.

In the general air conditioning vent mode, there is no system able to check the open/closed status of the air vents, so when an air vent outlet is closed, airflow is concentrated in another outlet, and noise is generated due to the concentrated airflow. However, in the case of using an electric vent, it is possible to know whether an air vent is open or closed. By receiving closed state information for each outlet to control airflow, keeping constant airflow for each outlet.

For example, there is a technology to control airflow by a controller that is an airflow control technology applied when a driver rides a vehicle alone. Here, energy may be saved by closing the outlet at a passenger side by the air conditioning system and reducing voltage by a predetermined percentage considering the closed portion of the outlet. However, in this technology, because the outlet at the passenger side is closed by the air conditioning system, problems have not yet been resolved, such as increased airflow from the outlet at the driver's side and noise not being reduced. Moreover, when the air vent at the driver's side is closed manually, the outlet is closed in addition to the outlet at the passenger side. Thus, even if a predetermined percentage of the outlets is closed, the airflow and noise increase, and airflow control is still not properly made. Furthermore, when a user manually closes a particular air vent, there is a problem in that the vehicle may not determine whether the air vent is open or closed.

The above information disclosed in this Background section is only to enhance understanding of the background of the present disclosure. Therefore, the Background section may contain information that does not form the prior art that is already known to a person of ordinary skill in the art.

### SUMMARY OF THE DISCLOSURE

In view of the foregoing, there is need for an automotive airflow control device and a control method therefor, in which it is possible to know whether air vents are open or closed even in an air conditioning vent mode or an electric vent. By checking the open or closed status of each outlet to control airflow and to maintain constant airflow for each outlet, noise may be reduced, and airflow may be kept constant.

The present disclosure has been made in an effort to solve the above-described problems associated with the prior art. Objects of the present disclosure are to provide an automotive airflow control device and a control method therefor. In the device and method, it is possible to know whether air vents are open or closed, even in an air conditioning vent mode or an electric vent. By checking the open or closed status of each discharge port to control airflow and to maintain constant airflow for each discharge port, noise may be reduced, and airflow may be kept constant.

The objects of the present disclosure are not limited to the foregoing. Other objects of the present disclosure not mentioned herein may be understood based on the following description and may be understood more clearly through the embodiments of the present disclosure. In addition, the objects of the present disclosure may be realized by the devices and methods and combinations thereof indicated in the claims.

To achieve the objects of the present disclosure, an automotive airflow control device is provided including the following configuration. In one aspect, the present disclosure provides an automotive airflow control device configured to discharge cold air or warm air into a vehicle compartment. The device may include at least one or more air vents mounted in the vehicle and configured to discharge cold air or warm air into the vehicle compartment. The device may also include a controller configured to receive open/closed information for the air vents to control airflow. The controller may check the number of closed air vents, calculate a control constant value based on the number of closed air vents, and control airflow provided to the air vents.

In an embodiment, the air vents may have a discharge port formed or provided therein through which cold air or warm air is discharged.

In another embodiment, the controller may pre-store a reference voltage consumed depending on the number of closed air vents.

In still another embodiment, the controller may measure airflow discharged from each of the at least one or more air vents mounted in the vehicle.

In yet another embodiment, the controller may measure airflow by sequentially closing each of the at least one or more air vents.

In still yet another embodiment, the controller may calculate a control constant so that airflow measured at each of the at least one or more air vents is calculated to be a reference value.

In a further embodiment, the controller may pre-store a control constant to control airflow.

In another further embodiment, the controller may calculate the pre-stored control constant and a set stage voltage to derive a control voltage.

Furthermore, to achieve the objects of the present disclosure, a method is provided for controlling automotive airflow including the following configuration. In one aspect, the present disclosure provides a method for controlling airflow in discharging cold air or warm air into a vehicle compartment. The method may include a first step of receiving, by a controller, open/closed information for at least one or more air vents. The method may also include a second step of checking, by the controller, the number of closed air vents based on airflow measured at the first step. The method may further include a third step of checking, by the controller, the open/closed information for the air vents received from the second step and calculating a control constant and a set stage voltage to derive a control voltage. The method may also include a fourth step of outputting, by the controller, the control voltage.

In an embodiment, a step preceding the first step may include sequentially closing each of the at least one or more air vents and storing airflow values or amounts.

In another embodiment, the airflow values or amounts may be data including an airflow value or amount measured by closing one of the air vents, an airflow value or amount measured by closing two of the air vents, and an airflow value or amount measured by closing three of the air vents.

In still another embodiment, the control constant and the set stage voltage used at the third step may be pre-stored data.

Other aspects and embodiments of the present disclosure are discussed below.

It is to be understood that the term “vehicle” or “vehicular” or other similar terms as used herein are inclusive of motor vehicles in general. Such motor vehicles may encompass passenger automobiles including sport utility vehicles (SUV), buses, trucks, various commercial vehicles, watercraft including a variety of boats and ships, aircraft, and the like. Such motor vehicles may also include hybrid vehicles, electric vehicles, plug-in hybrid electric vehicles, hydrogen-powered vehicles, and other alternative fuel vehicles (e.g., fuels derived from resources other than petroleum. As referred to herein, a hybrid vehicle is a vehicle that has two or more sources of power, for example, a vehicle powered by both gasoline and electricity.

The above and other features of the present disclosure are discussed below.

### BRIEF DESCRIPTION OF THE DRAWINGS

The above and other features of the present disclosure are described in detail with reference to certain example embodiments thereof illustrated in the accompanying drawings, which are given hereinbelow by way of illustration only, and thus are not limitative of the present disclosure, and wherein:

FIG. 1 is a perspective view illustrating the overall appearance of an automotive airflow control device of the present disclosure;

FIG. 2 is a block diagram showing the structure of an automotive airflow controller of the present disclosure; and

FIG. 3 is a flow chart of a method for controlling airflow of the present disclosure, and in an automotive airflow control device.

It should be understood that the appended drawings are not necessarily drawn to scale, presenting a somewhat simplified representation of various features illustrative of the basic principles of the present disclosure. The specific design features of the present disclosure, including, for example, specific dimensions, orientations, locations, and shapes, will be determined in part by the particular intended application and usage environment.

In the figures, the reference numbers refer to the same or equivalent parts of the present disclosure throughout the several figures of the drawings.

### DETAILED DESCRIPTION

Hereinafter, embodiments of the present disclosure are described in detail with reference to the accompanying drawings. The embodiments of the present disclosure may be modified into various forms, and the scope of the present disclosure should not be construed as being limited to the following embodiments. The embodiments are provided to more completely explain the present disclosure to those having ordinary skill in the art.

In addition, terms such as “ . . . portion,” “ . . . unit,” “ . . . module,” and the like used in this specification each refer to a unit that processes at least one function or operation, and may be implemented as hardware, software, or a combination thereof.

The terminology used herein is for the purpose of describing particular embodiments only and is not intended to be limiting. A singular representation may include a plural representation unless it represents a definitely different meaning from the context.

In the description and claims of the present disclosure, directions such as up, down, left and right (or sides), front, back, and the like are determined based on the relative positions in the drawings or the relative positions among the components for the convenience of explanation, not for the purpose of limiting the scope of the disclosure. Therefore, each direction described below is based on this principle, except in cases where it is specifically limited otherwise.

Hereinafter, embodiments are described in detail with reference to the accompanying drawings. In the description given with reference to the accompanying drawings, the same or corresponding components are assigned the same reference numerals, and a description thereof is not repeated. When a component, device, element, or the like of the present disclosure is described as having a purpose or performing an operation, function, or the like, the component, device, or element should be considered herein as being “configured to” meet that purpose or perform that operation or function.

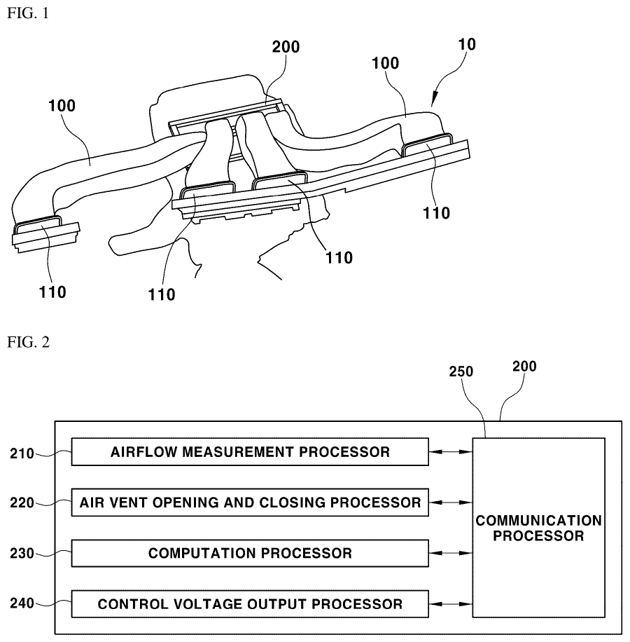

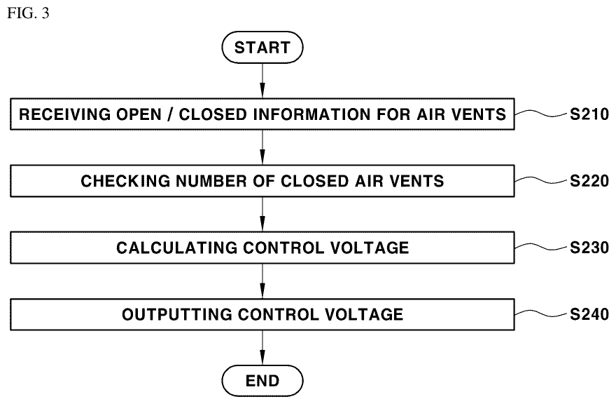

FIG. 1 is a perspective view illustrating the overall appearance of an automotive airflow control device of the present disclosure. FIG. 2 is a block diagram showing the structure of an automotive airflow controller of the present disclosure. FIG. 3 is a flow chart of a method for controlling airflow of the present disclosure, such as for or through an automotive airflow control device.

First, referring to FIG. 1, the airflow control device according to the present disclosure is mounted in a vehicle in the longitudinal direction of a dashboard (i.e., in a widthwise direction relative to the vehicle) and may provide heated, cooled, or vent air as needed by opening or closing one or more air vents to efficiently heat and cool a vehicle compartment. Moreover, the air vents of the airflow control device of the present disclosure includes a driver's side air vent, a passenger side air vent, and a central air vent, and may additionally include a console air vent or other such air vents.

An automotive airflow control device 10 of the present disclosure may include an air conditioning case having formed therein an air passage. The air passage may be configured to liaise between an air inlet port and an air discharge port. The device 10 may also include an evaporator and a heater core mounted sequentially at a predetermined distance in the air passage. The device 10 may further include a blower having an outlet connected to the air inlet port in the air conditioning case and configured to blow air into the air conditioning case. The automotive airflow control device 10 may further include a heat exchanger provided within the air conditioning case and configured to perform heat exchange with the air blown through the blower, depending on various modes.

Moreover, the airflow control device 10 of the present disclosure may be adopted in, in addition to a vehicle provided with an electric air vent, a vehicle equipped with a system having components capable of transmitting signals for opening and closing of the discharge port.

An air vent 100 of the airflow control device 10 of the present disclosure has a discharge port 110 formed or provided therein through which cold air or warm air is discharged. The airflow control device 10 includes a controller 200 configured to control the airflow discharged through the discharge port 110.

The controller 200 of the airflow control device 10 of the present disclosure may receive open/closed information for the air vents 100, check the number of closed air vents 100, calculate a control constant value based on the number of closed air vents 100, and control airflow towards the air vents 100.

Referring to FIG. 2, the controller 200 of the airflow control device of the present disclosure includes an airflow measurement processor 210, an air vent opening and closing processor 220, a computation processor 230, a control voltage output processor 240, and a communication processor 250.

The airflow measurement processor 210 of the controller 200 of the present disclosure measures airflow discharged from the air vents 100, which may be provided as at least one or more air vents. Specifically, the airflow measurement processor 210 measures airflow discharged from each of the at least one or more air vents mounted in the vehicle and sets the same as a reference airflow value or amount.

Next, the air vent opening and closing processor 220 of the controller 200 of the present disclosure closes any one of the discharge ports 110 in the at least one or more air vents 100 and measures the airflow. Thereafter, the air vent opening and closing processor 220 closes two of the discharge ports 110 in the at least one or more air vents 100 and measures the airflow therefrom. Thereafter, the air vent opening and closing processor 220 closes three of the discharge ports 110 in the at least one or more air vents 100 and measures the airflow therefrom. In other words, the air vent opening and closing processor 220 of the present disclosure measures the airflow by sequentially closing the discharge ports 110 in the at least one or more air vents 100 one by one.

The computation processor 230 of the controller 200 of the present disclosure measures airflow being discharged based on the number of closed discharge ports 110 in the air vents 100 to derive a control constant. For example, the computation processor 230 closes one of the discharge ports 110 in the at least one or more air vents 100 and measures the value or amount of airflow discharged from the other discharge ports 110, which are not closed, to derive a control constant value. For example, assuming that the reference airflow value or amount measured by the airflow measurement processor 210 is set to 47 CMH (Cubic Meter Hour or m³/h) and the airflow value or amount when one of the discharge ports 110 is closed is derived to be 55.9 CMH, the control constant may be calculated to be 0.84. The computation processor 230 may calculate the control constant as above using Equation 1.

$$Reference airflow value = Discharged - airflow value depending on the number of closed discharge ports in the least one or more air vents \times K ( Control constant )$$

When Equation 1 above is applied, the computation processor 230 of the present disclosure may derive the control constant K as shown below.

$$47 CMH = 55.9 CMH \times K ( Control constant ) \qquad Equation 2$$

Therefore, the control constant K of the present disclosure may be calculated to be 0.84.

The control constant when two of the discharge ports in the at least one or more air vents 100 are closed may also be calculated.

By applying Equation 1 to calculate the reference airflow value and the discharged-airflow value when two discharge ports are closed, the control constant may be calculated as follows.

$$* 47 CMH = 61.5 CMH \times K ( Control constant ) \qquad Equation 3$$

Therefore, the control constant of the present disclosure may be 0.76.

The control constant when three of the discharge ports in the at least one or more air vents are closed may also be calculated.

By applying Equation 1 to calculate the reference airflow value and the discharged-airflow value when three discharge ports are closed, the control constant may be calculated as follows.

$$47. CMH = 72. CMH \times control constant \qquad Equation 4$$

Therefore, the control constant of the present disclosure may be 0.65.

Therefore, by applying Equation 1 as above, a control constant depending on the number of closed discharge ports of the present disclosure may be derived.

Meanwhile, by applying the stage of the airflow control device of the present disclosure from Stage 2 to State 8 (the intensity of airflow), airflow values may be measured as shown in [Table 1 below.

TABLE 1

| | | Discharged- | Discharged- | Discharged- |
|---|---|---|---|---|
| | | airflow value | airflow value | airflow value |
| | Reference | when one | when two | when three |
| | airflow | discharge port | discharge ports | discharge ports |
| Stage | value | is closed | are closed | are closed |
| 1 | 47.0 | 55.9 | 61.5 | 72.0 |
| 2 | 63.1 | 75.0 | 82.5 | 96.0 |
| 3 | 75.5 | 89.2 | 98.5 | 115.0 |
| 4 | 89.8 | 106.0 | 116.0 | 136.0 |
| 5 | 103.8 | 123.1 | 134.9 | 157.0 |
| 6 | 116.4 | 138.6 | 150.5 | 179.0 |
| 7 | 127.8 | 152.3 | 165.0 | 196.2 |
| 8 | 134.3 | 159.0 | 174.0 | 205.0 |

First, in the air vent of the airflow control device of the present disclosure, according to Equation 1, the control constant may be 0.84 when the intensity of airflow is set to Stage 1 and one of the discharge ports in the air vents is closed. The control constant may be 0.76 when two discharge ports are closed. The control constant may be 0.65 when three discharge ports are closed. Moreover, the control constant may also be 0.84 when the intensity of airflow is set to Stage 2 and one of the discharge ports in the air vents is closed. The control constant may also be 0.76 when two discharge ports are closed. The control constant may also be 0.65 when three discharge ports are closed.

Meanwhile, the control constant may vary depending on the reference discharged-airflow value or amount and may also vary depending on an HVAC mode or a mode to blow cold air or warm air. The airflow value as in Table 1 above is not fixed, and the reference airflow value and the control constant may vary depending on the value of airflow discharged from the vehicle.

Meanwhile, the control voltage output processor 240 of the controller 200 of the present disclosure may derive a control voltage by calculating the control constant and the set stage voltage calculated by the computation processor 23. Here, the set stage voltage is a voltage that is set depending on a stage (the strength of the blown air) and may be data in which an appropriate voltage according to the stage set by a driver of the vehicle or a worker who manufactured the vehicle is pre-stored. The set stage voltage may vary depending on the type of vehicle or the mode and may be set arbitrarily by the manufacturer or driver of the vehicle.

Meanwhile, the equations in Table 2 below may be used to derive a control voltage.

TABLE 2

| | |
|---|---|
| Reference airflow value | Control voltage = Set stage voltage × 1 |
| | (Control constant, κ) |
| When one discharge port | Control voltage = Set stage voltage × 0.84 |
| in the air vents is closed | (Control constant, κ) |
| When two discharge ports | Control voltage = Set stage voltage × 0.76 |
| in the air vents are closed | (Control constant, κ) |
| when three discharge ports | Control voltage = Set stage voltage × 0.65 |
| in the air vents are closed | (Control constant, κ) |
| When all discharge ports | control voltage = Set stage voltage × 0 |
| are closed | (Control constant, κ) |

The control voltage value may be derived by applying the equations in Table 2 above. Using the control voltage, appropriate airflow may be provided to thereby improve fuel efficiency and to reduce the noise occurred due to the discharge port in the air vent being closed.

The communication processor 250 of the controller 200 of the present disclosure is an internal communication module for communication among electronic devices inside the vehicle. The communication processor 250 may use an internal communication protocol, such as a controller area network (CAN), a local interconnection network (LIN), FlexRay, or Ethernet, to set a pre-stored reference airflow value and to transmit and receive airflow values or amounts from outside. Here, the values or amounts may be stored and used as a database.

The controller 200 of the present disclosure may measure, compare, store, and control the entire airflow discharged from the discharge ports in the air vents 100. Moreover, the controller 200 of the present disclosure may control data flow for the airflow value or amount from outside or data flow for the preset airflow value or amount so that the airflow measurement processor 210, the air vent opening and closing processor 220, the computation processor 230, the control voltage output processor 240, and the communication processor 250 may each perform their own functions.

Meanwhile, FIG. 3 is a flow chart of the method for controlling automotive airflow of the present disclosure.

As shown in FIG. 3, in the method for controlling automotive airflow of the present disclosure, first, when the vehicle starts and the airflow control device operates, the airflow discharged from the discharge port in the air vent is measured. Thereafter, information on the airflow being discharged from the discharge port in the air vents of the present disclosure is collected and open/closed information of the discharge ports currently open or closed is received at step S210.

Then, the number of closed discharge ports is checked at step S220. Here, how many discharge ports are closed is calculated to derive a control constant.

Thereafter, a set stage voltage and a control constant are calculated based on the number of closed discharge ports to derive a control voltage at step S230.

Next, the control voltage is output, and airflow is discharged according to the control voltage at step S240.

As should be apparent from the above description, the present disclosure may obtain the following effects by the configuration, combination, and operation relationship described above with the present embodiment.

In the automotive airflow control device and the control method therefor according to the present disclosure, it is possible to know whether air vents are open or closed even in an air conditioning vent mode or an electric vent. By checking the open or closed status of each discharge port to control airflow and to maintain constant airflow for each discharge port, noise may be reduced, and airflow may be kept constant.

Although the present disclosure has been described in connection with specific features such as detailed components as well as limited embodiments and drawings, these are merely provided to aid in the general understanding of the present disclosure. The present disclosure is not limited to the above embodiments, and those having ordinary skill in the art should appreciate that various changes and modifications are possible from the above description.

The present disclosure is thus not limited to the example embodiments described above. Rather, the present disclosure is intended to include the following appended claims, and all modifications, equivalents, and alternatives falling within the spirit and scope of the following claims.

What is claimed is:

1. An automotive airflow control device, the device comprising:
one or more air vents mounted in a vehicle and configured to discharge cold air or warm air into a vehicle compartment; and
a controller configured to receive open/closed information for the one or more air vents to control airflow,
wherein the controller checks a number of closed air vents, calculates a control constant value based on the number of closed air vents, and controls airflow provided to the one or more air vents.

2. The device of claim 1, wherein the one or more air vent each has a discharge port therein through which cold air or warm air is discharged.

3. The device of claim 1, wherein the controller pre-stores a reference voltage consumed depending on the number of closed air vents.

4. The device of claim 1, wherein the controller measures airflow discharged from each of the one or more air vents mounted in the vehicle.

5. The device of claim 1, wherein the controller measures airflow by sequentially closing each of the one or more air vents.

6. The device of claim 1, wherein the controller calculates a control constant so that airflow measured at each of the one or more air vents is calculated to be a reference value.

7. The device of claim 1, wherein the controller pre-stores a control constant to control airflow.

8. The device of claim 7, wherein the controller calculates the pre-stored control constant and a set stage voltage to derive a control voltage.

9. A method for controlling airflow in discharging cold air or warm air into a vehicle compartment, the method comprising:
a first step of receiving, by a controller, open/closed information for one or more air vents;
a second step of checking, by the controller, a number of closed air vents based on airflow measured at the first step;
a third step of checking, by the controller, the open/closed information for the one or more air vents received from the second step, and calculating a control constant and a set stage voltage to derive a control voltage; and
a fourth step of outputting, by the controller, the control voltage.

10. The method of claim 9, wherein a step preceding the first step comprises sequentially closing each of the one or more air vents and respectively storing one or more airflow amounts.

11. The method of claim 10, wherein:
the one or more air vents includes three or more air vents; and
the one or more airflow amounts are data comprising a first airflow amount measured by closing one of the three or more air vents, a second airflow amount measured by closing two of the three or more air vents, and a third airflow value measured by closing three of the three or more air vents.

12. The method of claim 9, wherein the control constant and the set stage voltage used at the third step are pre-stored data.
